(19) United States
(12) Patent Application Publication
(10) Pub. No.: US 2006/0133980 A1
(43) Pub. Date: Jun. 22, 2006

(54) Carbon material for battery electrode and production method and use thereof

(76) Inventors: Youichi Nanba, Kanagawa (JP); Masataka Takeuchi, Kanagawa (JP); Akinori Sudoh, Nagano (JP); Satoshi Iinou, Nagano (JP)

Correspondence Address: SUGHRUE MION, PLLC, 2100 PENNSYLVANIA AVENUE, N.W., SUITE 800, WASHINGTON, DC, 20037, US

(21) Appl. No.: 10/559,615

(22) PCT Filed: Jun. 4, 2004
(86) PCT No.: PCT/JP04/08157

§ 371 Date: Dec. 2, 2005

Related U.S. Application Data
(60) Provisional application No. 60/477,755, filed on Jun. 12, 2003.

(30) Foreign Application Priority Data
Jun. 5, 2003 (JP) 2003-160709

(51) Int. Cl. H01M 4/58; H01M 8/02

(52) U.S. Cl. 423/445 R; 429/231.8; 429/34

(57) ABSTRACT

The invention relates to a carbon material for forming a battery electrode, comprising carbon powder having a homogeneous structure which is produced by causing an organic compound, serving as a ra.w material of a polymer, to deposit onto and/or permeate into carbonaceous particles, and subsequently polymerizing the organic compound, followed by thermal treatment at a temperature of 1,800 to 3,300° C., which comprises a structure which is substantially uniform throughout the entirety of the particle from the surface to the central core where a graphite crystal structure region and an amorphous structure region are distributed. By using the material, a battery having high discharging capacity and low irreversible capacity, with excellent coulombic efficiency and excellent cycle characteristics can be fabricated. The carbon material of the invention may contain carbon fiber filaments. Average roundness, BET specific surface area, true density, laser Roman R value, and average particle size were investigated.

### CROSS-REFERENCE TO RELATED APPLICATIONS

This is an application filed pursuant to 35 U.S.C. Section 111(a) with claiming the benefit of U.S. provisional application Ser. No. 60/477,755 filed Jun. 12, 2003 under the provision of 35 U.S.C. 111(b), pursuant to 35 U.S.C. Section 119(e)(1).

### TECHNICAL FIELD

The present invention relates to an electrode material for producing a non-aqueous electrolyte secondary battery having high charging/discharging capacity and exhibiting excellent charging/discharging cycle characteristics and excellent characteristics under load of large electric current, to an electrode formed of the material, and to a non-aqueous electrolyte secondary battery including the electrode. More particularly, the present invention relates to a negative electrode material for producing a lithium secondary battery, to a negative electrode formed of the material, and to a lithium secondary battery including the electrode.

### BACKGROUND ART

With the developments in portable apparatuses reduced in size and weight and having high performance, increasing demand has arisen for a lithium ion secondary battery having high energy density; i.e., a lithium ion secondary battery of high capacity. Most lithium ion secondary batteries employ, as a negative electrode material, graphite fine powder, which can intercalate lithium ions between graphite layers. Since graphite of higher crystallinity exhibits higher discharging capacity, attempts have been made to employ graphite material with high crystallinity such as natural graphite as a negative electrode material for producing a lithium ion secondary battery. In recent years, there has been developed a graphite material exhibiting a discharging capacity within a range of 350 to 360 mAh/g in practical use, which is nearly equal to the theoretical discharging capacity of graphite, 372 mAh/g.

However, employment of graphite material causes problems in that the higher the crystallinity of the graphite material, the more the irreversible capacity is increased and the more the coulombic efficiency (i.e., discharging capacity/charging capacity at the first charging/discharging cycle) is lowered, assumedly due to decomposition of an electrolytic solution (see J. Electrochem. Soc., Vol. 117, 1970, pp. 222 to 224). In order to solve such problems, there has been proposed a negative electrode material containing a carbon material with high crystallinity whose surface is coated with amorphous carbon, thereby suppressing reduction in coulombic efficiency and increase in irreversible capacity, assumedly due to decomposition of an electrolytic solution, as well as suppressing deterioration of cycle characteristics (see Japanese Patent No. 2643035 (U.S. Pat. No. 5,344,726) and Japanese Patent No. 2976299). However, the technique disclosed in Japanese Patent No. 2643035 (U.S. Pat. No.5,344,726), in which an amorphous carbon layer is formed on the surface of a carbon material having high crystallinity by means of CVD (chemical vapor deposition), involves serious practical problems in terms of production cost and mass productivity. In addition, the negative electrode material disclosed in this patent document, which has a two-layer structure including the amorphous carbon layer, involves problems (e.g., low capacity and low coulombic efficiency) which are associated with the amorphous carbon layer. Japanese Patent No. 2976299 discloses a technique employing liquid-phase carbonization comprising covering surface of the material with coal-tar pitch or the like and involving heat-treatment, which is advantageous from the viewpoints of production cost and mass productivity. However, similar to the case of the aforementioned technique, the technique also involves the problems associated with an amorphous carbon layer.

Meanwhile, Japanese Patent Application Laid-Open (kokai) No. 2001-6662 proposes a method in which a thermosetting resin material is dissolved in an organic solvent, the resultant solution is mixed with graphite powder, the resultant mixture is subjected to molding, and the resultant product is thermally cured and then fired. However, in this method, since the thermosetting resin material insufficiently permeates to the interior of the graphite powder; i.e., the thermosetting resin is merely deposited onto the surface of the graphite powder, a homogeneous composite material fails to be formed from the thermosetting resin and graphite. Therefore, this method fails to completely solve problems associated with an amorphous carbon layer.

### DISCLOSURE OF INVENTION

An object of the present invention is to provide an electrode material for producing a battery having high discharging capacity and low irreversible capacity, and exhibiting excellent coulombic efficiency and excellent cycle characteristics, which material can solve problems inherent in the use of graphite material having high crystallinity and in a case where an amorphous carbon layer is provided in the material.

In order to solve the aforementioned problems, the present inventors have performed extensive studies, and as a result have found that when carbonaceous particles are uniformly impregnated with an organic compound serving as a raw material of a polymer to thereby form a composite material, and the organic compound is polymerized, followed by carbonization and firing, there is produced carbon powder comprising particles each having a structure which is substantially uniform throughout the entirety of the particle from the surface to the central core, and that when the carbon powder is employed as an electrode material for producing a battery, the resultant battery exhibits high discharging capacity comparable to that of a battery produced from graphite particles having high crystallinity, and exhibits excellent coulombic efficiency, excellent cycle characteristics, and low irreversible capacity, thereby accomplishing the present invention.

Accordingly, the present invention provides a carbon material for forming a battery electrode, a method for producing the carbon material, and use of the carbon material, as described below.

1. A carbon material for forming a battery electrode, comprising carbon powder having a homogeneous structure which is produced by causing an organic compound, serving as a raw material of a polymer, to deposit onto and/or permeate into carbonaceous particles, and subsequently polymerizing the organic compound, followed by thermal treatment at a temperature of 1,800 to 3,300° C.

2. The carbon material for forming a battery electrode according to 1 above, wherein the polymerization is carried out under heating at a temperature of 100 to 500° C.

3. The carbon material for forming a battery electrode according to 1 or 2 above, wherein the organic compound is a raw material of at least one polymer selected from the group consisting of a phenol resin, a polyvinyl alcohol resin, a furan resin, a cellulose resin, a polystyrene resin, a polyimide resin, and an epoxy resin.

4. The carbon material for forming a battery electrode according to 3 above, wherein the organic compound is a raw material of a phenol resin.

5. The carbon material for forming a battery electrode according to 4 above, wherein a drying oil or a fatty acid derived therefrom is added during the course of reaction of the phenol resin raw material.

6. The carbon material for forming a battery electrode according to any one of 1 through 5 above, wherein a graphite crystal structure region and an amorphous structure region are distributed throughout the entirety of a particle constituting the carbon material from the surface of the particle to a center portion thereof.

7. The carbon material for forming a battery electrode according to 6 above, wherein, with respect to a transmission electron microscope bright-field image of a cross section of a thin piece obtained by cutting each of the particles constituting the carbon material for forming a battery electrode, in a selected area diffraction pattern of an arbitrarily selected 5-μm square region in the section, the area ratio of a graphite crystal structure region having a diffraction pattern formed of two or more spots to an amorphous structure region having a diffraction pattern formed of only one spot attributed to (002) plane is 99 to 30:1 to 70.

8. The carbon material for forming a battery electrode according to any one of 1 through 7 above, which is produced by performing multiple times a process of causing the organic compound to deposit onto and/or permeate into the carbonaceous particles and subsequently polymerizing the organic compound, followed by thermal treatment at a temperature of 1,800 to 3,300° C.

9. The carbon material for forming a battery electrode according to any one of 1 through 8 above, wherein the amount of the organic compound is 4 to 500 parts by mass on the basis of 100 parts by mass of the carbonaceous particles.

10. The carbon material for forming a battery electrode according to 9 above, the amount of the organic compound is 100 to 500 parts by mass on the basis of 100 parts by mass of the carbonaceous particles.

11. The carbon material for forming a battery electrode according to any one of 1 through 10 above, which contains boron in an amount of 10 to 5,000 ppm.

12. The carbon material for forming a battery electrode according to 11 above, wherein boron or a boron compound is added after polymerization of the organic compound, followed by thermal treatment at 1,800 to 3,300° C.

13. The carbon material for forming a battery electrode according to any one of 1 through 12 above, wherein the carbonaceous particles are natural graphite particles, particles formed of petroleum pitch coke, or particles formed of coal pitch coke.

14. The carbon material for forming a battery electrode according to 13 above, wherein the carbonaceous particles have an average particle size of 10 to 40 μm and an average roundness of 0.85 to 0.99.

15. The carbon material for forming a battery electrode according to any one of 1 through 14 above, which contains carbon fiber having a filament diameter of 2 to 1,000 nm.

16. The carbon material for forming a battery electrode according to 15 above, wherein at least a portion of the carbon fiber is deposited onto the surface of the carbon powder.

17. The carbon material for forming a battery electrode according to 15 or 16 above, wherein the amount of the carbon fiber is 0.01 to 20 parts by mass on the basis of 100 parts by mass of the carbonaceous particles.

18. The carbon material for forming a battery electrode according to any one of 15 through 17 above, wherein the carbon fiber is vapor grown carbon fiber, each fiber filament of the carbon fiber having an aspect ratio of 10 to 15,000.

19. The carbon material for forming a battery electrode according to 18 above, wherein the vapor grown carbon fiber is graphitized carbon fiber which has undergone thermal treatment at 2,000° C. or higher.

20. The carbon material for forming a battery electrode according to 18 or 19 above, wherein each fiber filament of the vapor grown carbon fiber includes a hollow space extending along its center axis.

21. The carbon material for forming a battery electrode according to any one of 18 through 20 above, wherein the vapor grown carbon fiber contains branched carbon fiber filaments.

22. The carbon material for forming a battery electrode according to any one of 18 through 21 above, wherein the vapor grown carbon fiber has, at (002) plane, an average interlayer distance (d₀₀₀₂) of 0.344 nm or less as measured by means of X-ray diffractometry.

23. The carbon material for forming a battery electrode according to any one of 1 through 22 above, wherein the carbon powder satisfies at least one of the following requirements (1) through (6):

(1) average roundness as measured by use of a flow particle image analyzer is 0.85 to 0.99;

(2) C₀ of (002) plane as measured through X-ray diffractometry is 0.6703 to 0.6800 nm, La (the crystallite size as measured in the a-axis orientation) is greater than 100 nm, and Lc (the crystallite size as measured in the c-axis orientation) is greater than 100 nm;

(3) BET specific surface area is 0.2 to 5 m²/g;

(4) true density is 2.21 to 2.23 g/cm³;

(5) laser Raman R value (the ratio of the intensity of a peak at 1,360 cm⁻¹ to that of a peak at 1,580 cm⁻¹ in the laser Raman spectrum) is from 0.01 to 0.9; and

(6) average particle size as measured through laser diffractometry is 10 to 40 μm.

24. A method for producing a carbon material for forming a battery electrode containing carbon powder having a homogeneous structure, comprising a step of treating carbonaceous particles with an organic compound serving as a raw material of a polymer or a solution of the organic compound, to thereby cause the organic compound to deposit onto and/or permeate into the carbonaceous particles; a step of polymerizing the organic compound; and a step of thermally treating the resultant product at a temperature of 1,800 to 3,300° C.

25. A method for producing a carbon material for forming a battery electrode containing carbon powder having a homogeneous structure and carbon fiber, comprising a step of treating carbonaceous particles with a mixture of an organic compound serving as a raw material of a polymer and carbon fiber having a filament diameter of 2 to 1,000 nm or with a solution of the mixture, to thereby cause the organic compound to deposit onto and/or permeate into the carbonaceous particles and cause the carbon fiber to adhere to the particles; a step of polymerizing the organic compound; and a step of thermally treating the resultant product at a temperature of 1,800 to 3,300° C., wherein at least a portion of the carbon fiber is deposited onto the surface of the carbon powder.

26. An electrode paste comprising the carbon material for forming a battery electrode as recited in any of 1 through 23 above and a binder.

27. An electrode comprising a molded product of the electrode paste as recited in 26 above.

28. A battery comprising the electrode as recited in 27 above.

29. A secondary battery comprising the electrode as recited in 27 above.

30. The secondary battery according to 29 above, which comprises a non-aqueous electrolytic solution and/or a non-aqueous polymer electrolyte, wherein a non-aqueous solvent employed for the non-aqueous electrolytic solution and/or the non-aqueous polymer electrolyte contains at least one selected from the group consisting of ethylene carbonate, diethyl carbonate, dimethyl carbonate, methyl ethyl carbonate, propylene carbonate, butylene carbonate, and vinylene carbonate.

31. A fuel cell separator comprising, in an amount of 5 to 95 mass %, the carbon material for forming a battery electrode as recited in any of 1 through 23 above.

32. A fuel cell comprising the fuel cell separator as recited in 31 above.

### DETAILED DESCRIPTION OF INVENTION

The present invention will next be described in detail.

In the present invention, an organic compound serving as a raw material of a polymer is caused to sufficiently deposit onto and/or permeate into carbonaceous particles, and subsequently the organic compound is polymerized, followed by carbonization and firing of the resultant product, to thereby produce carbon powder comprising particles each having a structure which is substantially homogeneous throughout the entirety of the particle from the center core to the surface.

[1] Carbonaceous Particles

No particular limitations are imposed on the type of carbonaceous particles used as core material in the present invention, so long as the particles can intercalate lithium ions thereinto and release the ions therefrom. The larger the amount of lithium ions carbonaceous particles intercalate and release is, the more preferable. Therefore, the carbonaceous particles are preferably formed of graphite having a high crystallinity, such as natural graphite. It is preferable that the carbonaceous particles formed of graphite having a high crystallinity satisfy the following requirements: C₀ of (002) plane as measured through X-ray diffractometry is 0.6703 to 0.6800 nm (0.33515 to 0.3400 nm in terms of average interlayer distance (d₀₀₂)); La (the crystallite size as measured in the a-axis orientation) is greater than 100 nm; Lc (the crystallite size as measured in the c-axis orientation) is greater than 100 nm; and laser Raman R value (i.e., the ratio of the intensity of a peak at 1, 360 cm⁻¹ to that of a peak at 1,580 cm⁻¹ in the laser Raman spectrum) is from 0.01 to 0.9.

The carbonaceous particles may be particles formed of easy-graphitizable carbon material (soft carbon) which are graphitized through thermal treatment at 1,800 to 3,300° C. which is performed subsequently to a polymerization step. Specific examples of the carbonaceous particles include particles formed of coke such as petroleum pitch coke and coal pitch coke.

The carbonaceous particles having for example, a lump-like shape, a flaky shape, a spherical shape, or a fibrous shape may be used. It is preferable that the particles have a spherical shape or a lump-like shape. The carbonaceous particles serving as core material preferably have an average roundness of 0.85 to 0.99 as measured by use of a flow particle image analyzer. When the average roundness is lower than 0.85, the packing density of the carbon powder, serving as a carbon material for forming an electrode, fails to increase during the course of formation of an electrode, resulting in lowering of discharging capacity per unit volume. In contrast, the average roundness greater than 0.99 means that the carbonaceous particles contain virtually no fine particles which have low roundness, and thus discharging capacity fails to increase during the course of formation of an electrode. Moreover, it is preferable that the amount of particles having an average roundness of less than 0.90 contained in the carbonaceous particles be regulated to 2 to 20% by number of particles. The average roundness can be regulated by use of a particle shape control apparatus employing, for example, mechanofusion (surface fusion) treatment.

The carbonaceous particles preferably have an average particle size of 10 to 40 μm as measured by means of the laser diffraction scattering method. More preferably, the average particle size is 10 to 30 μm. Preferably, substantially no particles having a particle size falling within a range of 1 μm or less and/or 80 μm or more are present in the particle size distribution of the carbonaceous particles. The reason why such a particle size range is preferable is that when the particle size of the carbonaceous particles is large, the particle size of the carbon powder produced to serve as a carbon material for forming an electrode also becomes large, and cycle characteristic of a negative electrode of a secondary battery formed from the carbon powder are deteriorated due to micronization of the partcles through charging/discharging reaction. In contrast, when the particle size of the carbonaceous particles is small, the particles fail to efficiently participate in electrochemical reaction with lithium ions, resulting in lowering of capacity and deterioration of cycle characteristics.

In order to regulate the particle size distribution, any known technique such as pulverization or classification may be employed. Specific examples of the apparatus employed for pulverization include a hammer mill, a jaw crusher, and an impact mill. The classification may be air classification or classification employing a sieve. Examples of the apparatus employed for air classification include a turbo classifier and a turbo plex.

The carbonaceous particles may have both of the following two types of regions; i.e., crystalline (graphite crystalline) carbon regions and amorphous carbon regions, which are observed in a transmission electron microscope bright-field image. Conventionally, transmission electron microscopy has been employed for analysis of the structure of a carbon material. Particularly when high-resolution microscopy which enables observation of a carbon crystal plane in the form of a lattice image (in particular, a hexagonal network plane can be seen as a 002 lattice image) is employed, the layered structure of a carbon material can be directly observed at a magnification of about 400,000 or more. The crystalline carbon regions and amorphous carbon regions of the carbonaceous particles can be analyzed by means of transmission electron microscopy, which is an effective technique for characterization of carbon.

Specifically, a region to be investigated in the bright-field image of the carbonaceous particles is subjected to selected area diffraction (SAD) analysis, and investigation is performed on the basis of the resultant diffraction patterns. SAD analysis is described in detail in “Saishin no Tanso Zairyo Jikken Gijutsu (Bunseki Kaiseki Hen),” edited by The Carbon Society of Japan (SIPEC Corporation), pp. 18-26 and 44-50, and Michio Inagaki, et al., “Kaitei Tanso Zairyo Nyumon,” edited by The Carbon Society of Japan, pp. 29-40.

As used herein, the term “crystalline carbon region” refers to a region exhibiting a characteristic feature as observed in a diffraction pattern of, for example, a product obtained through treating easy-graphitizable carbon at 2,800° C. (specifically, a selected area diffraction pattern formed of two or more spots); and the “amorphous carbon region” refers to a region exhibiting a characteristic feature as observed in a diffraction pattern of, for example, a product obtained through treating hardly-graphitizable carbon at 1,200 to 2,800° C. (specifically, a selected area diffraction pattern formed of only one spot attributed to (002) plane).

In the carbonaceous particles, preferably, the area ratio of the crystalline carbon regions to the amorphous carbon regions is 95 to 50:5 to 50 as obtained from a bright-field image of the particles obtained by use of a transmission electron microscope. More preferably, the area ratio is 90 to 50:10 to 50. In the case where the area ratio of the crystalline carbon regions of the carbonaceous particles to the amorphous carbon regions thereof is lower than 50:50, the resultant negative electrode material fails to exhibit high discharging capacity. In contrast, in the case where the area ratio of the crystalline carbon regions to the amorphous carbon regions is higher than 95:5; i.e., the carbonaceous particles contain large amounts of the crystalline carbon regions, when the surfaces of the particles are incompletely coated with a carbon layer, coulombic efficiency is lowered and cycle characteristics are deteriorated, whereas when the surfaces of the particles are completely coated with a carbon layer, problems associated with formation of a two-layer structure arise, leading to lowering of capacity.

[2] Organic Compound

The organic compound employed in the present invention serves as a raw material for forming a polymer. When such a polymer-forming raw material is employed, the raw material can uniformly permeate into the inside of the carbonaceous particles serving as core material. In contrast, when a polymer per se is employed, due to its large molecular weight and high viscosity, the polymer cannot uniformly permeate into the inside of the carbonaceous particles as compared with the case where a polymer-forming raw material is employed, and excellent characteristics cannot be obtained in the resultant electrode material.

The polymer obtained through polymerization of the organic compound preferably exhibits adhesion to the carbonaceous particles and/or fibrous carbon. As used herein, a “polymer exhibiting adhesion” is referred to as such a polymer that when the polymer is present between the carbonaceous particles and fibrous carbon so as to bring these materials into contact with each other, these materials are united through chemical bonding by means of, for example, covalent bonds, van der Waals forces, or hydrogen bonds, or through physical adsorption by means of, for example, anchoring effect. Any polymer may be employed in the present invention, so long as the polymer, when undergoing any treatment such as mixing, stirring, removal of solvent, or thermal treatment, exhibits resistance against, for example, compression, bending, exfoliation, impact, tension or tearing such that the polymer causes substantially no exfoliation of the carbon layer. Preferably, the polymer is at least one species selected from the group consisting of a phenol resin, a polyvinyl alcohol resin, a furan resin, a cellulose resin, a polystyrene resin, a polyimide resin, and an epoxy resin. A phenol resin and a polyvinyl alcohol resin are more preferred, with a phenol resin being particularly preferred.

Firing of a phenol resin produces a dense carbonaceous material, for the following reason. A phenol resin obtained through chemical reaction of unsaturated bonds of the raw material of the phenol resin is considered to mitigate decomposition and to prevent effervescence during the course of thermal treatment (or firing).

Examples of the phenol resin which may be employed include phenol resins such as novolak and resol; and modified phenol resins obtained by partially modifying such phenol resins.

Examples of the organic compound serving as a raw material for preparing such a phenol resin include phenol compounds, aldehydes, necessary catalysts, and cross-linking agents.

As used herein, the term “phenol compound” refers to phenol and phenol derivatives. Examples of the phenol compounds include phenol, cresol, xylenol, alkylphenols having an alkyl group and 20 or less carbon atoms, and phenol compounds having four functional groups such as bisphenol A. The aldehyde is preferably formaldehyde, particularly preferably formalin, from the viewpoint of, availability, cost or the like. Also, the aldehyde may be paraformaldehyde and the like. The catalyst employed for reaction may be a basic substance which forms an —NCH₂ bond between phenol and benzene nucleus, such as hexamethylenediamine.

Of the phenol resins, a modified phenol resin containing a drying oil or a fatty acid derived therefrom is preferred. When such a phenol resin containing a drying oil or a fatty acid derived therefrom is employed, effervescence during the course of firing is further suppressed, and a denser carbonaceous layer is formed.

The phenol resin containing a drying oil or a fatty acid derived therefrom may be prepared through the following process: a process in which firstly a phenol compound and a drying oil are subjected to addition reaction in the presence of a strong acid catalyst, and subsequently a basic catalyst is added to the resultant reaction mixture such that the mixture exhibits basicity, followed by formalin addition reaction; or a process in which a phenol compound is reacted with formalin, and then a drying oil or a fatty acid derived therefrom is added to the resultant reaction mixture.

A drying oil is a vegetable oil which is dried and solidified in a relatively short period of time when it is spread so as to form a thin film and then allowed to stand in air. Examples of the drying oil include generally known oils such as tung oil, linseed oil, dehydrated castor oil, soybean oil, and cashew nut oil. Fatty acids derived from these drying oils may be employed.

The amount of the drying oil or a fatty acid derived therefrom is preferably 5 to 50 parts by mass on the basis of 100 parts by mass of the phenol resin (e.g., a product obtained through condensation of phenol and formalin). When the amount of the drying oil or a fatty acid derived therefrom exceeds 50 parts by mass, the resultant carbonaceous layer exhibits lowered adhesion to the carbonaceous particles serving as core material and fibrous carbon.

[3] Deposition and/or Permeation, and Polymerization of Organic Compound

The organic compound can be deposited onto and/or permeated into the carbonaceous particles by dispersing the carbonaceous particles under stirring in the organic compound or a solution thereof.

Preferably, the organic compound is used in the form of solution having a low viscosity, so that the organic compound is uniformly permeated into the inside of the carbonaceous particles. No particular limitations are imposed on the solvent employed for preparing the solution, so long as the polymer-forming raw material can be dissolved and/or dispersed in the solvent. Examples of the solvent include water, acetone, ethanol, acetonitrile, and ethyl acetate.

When a solvent exhibiting poor affinity for graphite powder (e.g., water) is employed, the graphite powder may be subjected to preliminary treatment such as surface oxidation before the solvent is added to the powder. The surface oxidation may be performed by means of any known technique, such as air oxidation, treatment with nitric acid or the like, or treatment with an aqueous potassium dichromate solution.

In order to sufficiently cause the organic compound or a solution thereof to permeate into void spaces present in the inside of the carbonaceous particles, evacuation may be performed one to ten and several times before stirring or during the course of stirring. Through evacuation, air remaining in void spaces in the inside of the carbonaceous particles can be removed, but in some cases, the organic compound is volatilized during evacuation. Therefore, evacuation may be performed after the particles are mixed with a solvent, and subsequently, after the pressure becomes normal again, the organic compound may be added to and mixed with the carbonaceous particles. The lower the degree of vacuum, the preferable. The preferable range is approximately 13 kPa to 0.13 kPa (approximately 100 torr to 1 torr).

Deposition and/or permeation of the organic compound may be performed under atmospheric pressure, increased pressure, or reduced pressure. Preferably, deposition of the organic compound is performed under reduced pressure, from the viewpoint of enhancement of affinity between the carbonaceous particles and the organic compound.

The amount of the organic compound used as polymer-forming raw material is preferably 4 to 500 parts by mass, more preferably 100 to 500 parts by mass, on the basis of 100 parts by mass of the carbonaceous particles. When the amount of the organic compound is excessively small, sufficient effects cannot be obtained, whereas the excessively large amount is disadvantageous in that the carbonaceous particles together form aggregates.

After completion of the above-described treatment, the organic compound is polymerized. No particular limitations are imposed on the polymerization conditions, so long as polymerization of the organic compound proceeds. However, in general, polymerization of the organic compound is performed under heating. The heating temperature varies in accordance with the type of the polymer-forming raw material, but, for example, polymerization can be performed at a temperature range of 100 to 500° C.

In the present invention, the process of causing the organic compound to deposit onto and/or permeate into the carbonaceous particles and subsequently polymerizing the organic compound may be repeated plural times. By repeating the process, a portion of the carbonaceous particles to which the organic compound is insufficiently deposited and/or permeated can be as small as possible.

Next will be specifically described the case where a raw material of a phenol resin used as the organic compound is deposited onto and/or permeated into the carbonaceous particles.

Firstly, phenol compound, aldehyde compound, a reaction catalyst, and the carbonaceous particles were added to a reaction container, and stirred. In this case, preferably, at least water serving as a solvent is allowed to be present in the container in an amount such that the resultant mixture can be stirred. The blending ratio by mol of the phenol compound to the aldehyde compound is preferably regulated to 1 (phenol compound): 1 to 3.5 (aldehyde compound). The amount of the carbonaceous particles is preferably regulated to 5 to 3,000 parts by mass on the basis of 100 parts by mass of the phenol compound.

As described above, evacuation may be performed one to ten-odd times before stirring or during the course of stirring. However, when the container is evacuated, large amounts of phenol compound and aldehyde compound are volatilized. Therefore, evacuation may be performed after the carbonaceous particles are mixed with water, and subsequently after the pressure becomes normal again, phenol compound and aldehyde compound may be added to and mixed with the carbonaceous particles.

After the polymer-forming raw material is sufficiently deposited onto and permeated into the carbonaceous particles through the above stirring process, the raw material is polymerized. Polymerization of the raw material can be performed under the same conditions as those for producing a typical phenol resin; for example, polymerization can be performed under heating at 100 to 500° C.

When phenol compound, aldehyde compound, a catalyst, the carbonaceous particles, and water are mixed together, at the initial stage of reaction, the viscosity of the resultant mixture becomes nearly equal to that of mayonnaise. As reaction proceeds, a product obtained through condensation reaction between the phenol compound and the aldehyde compound which contains the carbonaceous particles, begins to be separated from water in the resultant reaction mixture. After the reaction proceeds to a desired extent, by stopping the stirring of the mixture and then cooling the mixture, black particles are produced in the form of precipitate. The resultant particles can be used after washed and subjected to filtration.

The amount of the precipitated resin can be increased by increasing the concentrations of phenol compound and aldehyde compound in the reaction system, or can be decreased by reducing the phenol and formaldehyde concentrations. Therefore, the amount of the precipitated resin can be controlled by regulating the amount of water or the amounts of phenol compound and aldehyde compound. The amounts of these materials may be regulated before reaction. Alternatively, the amount of each of the materials may be regulated by adding the material dropwise to the reaction system during the course of reaction.

[4) Carbon Fiber

The carbon material for forming a battery electrode of the present invention may contain carbon fiber. In this case, particularly preferably, at least a portion of the carbon fiber is deposited onto the surface of the carbon powder constituting the carbon material.

The carbon fiber is preferably vapor grown carbon fiber which is produced through the vapor growth process, since the vapor grown carbon fiber exhibits high electrical conductivity, and each fiber filament thereof has a small diameter and a high aspect ratio. Among such vapor grown carbon fibers, those exhibiting higher electrical conductivity and high crystallinity are more preferred. When the carbon material of the present invention is employed for forming a negative electrode of a lithium ion battery or the like, it is preferable that the crystal growth direction of vapor grown carbon fiber contained in the material be parallel to the filament axis of filaments constituting the fiber and that the fiber filament have a branched structure. When the vapor grown carbon fiber is carbon fiber constituted by branched filaments, electrical connection is readily established between the carbon particles by means of the carbon fiber, whereby electrical conductivity is enhanced.

Vapor grown carbon fiber can be produced through, for example, by blowing a gasified organic compound together with iron serving as a catalyst into a high-temperature atmosphere.

The vapor grown carbon fiber may be used in as-produced state, or the carbon fiber may be used after further treated with heat at, for example, 800 to 1,500° C.; or after undergoing graphitization at, for example, 2,000 to 3,000° C. More preferably, carbon fiber which has undergone thermal treatment at about 1,500° C. is used.

The vapor grown carbon fiber is preferably constituted by branched carbon fiber filaments. Each fiber filament of the branched carbon fiber may have a hollow structure in which a hollow space extends throughout the filament, including a branched portion thereof. Therefore, each of carbon layers constituting the cylindrical structure of each filament assumes an uninterrupted layer. As used herein, the term “hollow structure” refers to a structure in which carbon layer(s) form a cylindrical shape, including a structure having a shape of incomplete cylinder, a structure having some broken portions and a structure in which the laminated two carbon layers are integrated into a single carbon layer. The cross section of the cylindrical structure does not necessarily assume a perfect circle shape, and may assume an elliptical shape or a polygonal shape. No particular limitations are imposed on the interlayer distance (d₀₀₂) of carbon crystal layers. The interlayer distance (d₀₀₂) of the carbon crystal layers as measured by means of X-ray diffractometry is preferably 0.344 nm or less, more preferably 0.339 nm or less, much more preferably 0.338 nm or less with the thickness (Lc) of the carbon crystal layer in the C axis direction being 40 nm or less.

The outer diameter of each fiber filament of the vapor grown carbon fiber is 2 to 1,000 nm, and the aspect ratio of the filament is 10 to 15,000. Preferably, the fiber filament has an outer diameter of 10 to 500 nm and a length of 1 to 100 gm (an aspect ratio of 2 to 2,000) or an outer diameter of 2 to 50 nm and a length of 0.5 to 50 μm (an aspect ratio of 10 to 25,000).

When the vapor grown carbon fiber is subjected to thermal treatment at 2,000° C. or higher after the carbon fiber has been produced, crystallinity of the carbon fiber is further enhanced, thereby increasing electrical conductivity. In such a case, an effective measure is addition of, for example, boron, which facilitates graphitization, to the carbon fiber before thermal treatment.

The amount of the vapor grown carbon fiber contained in the carbon material for forming an electrode is preferably 0.01 to 20 mass %, more preferably 0.1 to 15 mass %., much more preferably 0.5 to 10 mass %. When the amount of the carbon fiber exceeds 20 mass %, electrochemical capacity is lowered, whereas when the amount of the carbon fiber is less than 0.01 mass %, internal electrical resistance at a low temperature (e.g., −35° C.) increases.

The vapor grown carbon fiber has, on its surface, large amounts of irregularities and rough portions. Therefore, the vapor grown carbon fiber exhibits enhanced adhesion to the carbonaceous particles serving as core material, and thus, even in the case where charging/discharging cycles are repeated, the carbon fiber, which also serves as a negative electrode active substance and an electrical conductivity imparting agent, can keep adhering to the particles and is not dissociated therefrom, whereby electronic conductivity can be maintained and cycle characteristics are enhanced.

Further, when the vapor grown carbon fiber contains a large amount of branched carbon fiber filaments, the networks can be formed in an efficient manner, and thus high electronic conductivity and thermal conductivity are readily obtained. In addition, in such a case, fiber filaments are uniformly dispersed on the surface of active substances (carbon powder particles) to straddle among active substances in a networklike status as if wrapping the active substance, and thus the strength of the negative electrode is enhanced, and good contact is established between the particles.

Owing to the presence of the vapor grown carbon fiber between the particles, the carbon material can exhibit enhanced effect of retaining an electrolytic solution, and doping or dedoping of lithium ions is smoothly carried out even under low temperature conditions.

No particular limitations are imposed on the method for depositing carbon fiber onto the carbon powder constituting the carbon material for forming a battery electrode of the present invention. For example, in the step of causing the organic compound or a solution thereof to deposit onto and/or permeate into the carbonaceous particles serving as core material, carbon fiber comprising filaments having a diameter of 2 to 1,000 nm, may be added, and caused to adhere, via the organic compound, to the carbonaceous particles, to thereby deposit the carbon fiber onto the particles. Alternatively, after the organic compound is deposited onto the carbonaceous particles and subsequently the resultant particles are mixed with particles containing a mixture containing carbon fiber, the carbon fiber may be deposited onto the carbonaceous particles by stirring the resultant mixture.

No particular limitations are imposed on the stirring method, and for example, a stirring apparatus such as a ribbon mixer, a screw kneader, a Spartan ryuzer, a Lodige mixer, a planetary mixer, or a general-purpose mixer can be employed.

No particular limitations are imposed on the temperature and time for stirring, and the stirring temperature and time are appropriately determined in accordance with the components, viscosity and the like of the particles and organic compound. The stirring temperature is generally about 0° C. to about 150° C., preferably about 20° C. to about 100° C.

[5] Thermal Treatment Conditions

In order to increase charging/discharging capacity due to intercalation of lithium ions and the like, the crystallinity of the carbon material must be enhanced. Since the crystallinity of carbon is generally enhanced in accordance with the highest temperature in thermal hysteresis, in order to enhance battery performance, thermal treatment is preferably carried out at a higher temperature.

In the present invention, after the organic compound is polymerized, thermal treatment is carried out at 1,800 to 3,300° C., thereby performing carbonization and firing. The thermal treatment temperature is preferably 2,500° C. or higher, more preferably 2,800° C. or higher, particularly preferably 3,000° C. or higher.

Boron or a boron compound may be added before thermal treatment to promote graphitization through thermal treatment. Examples of the boron compound include boron carbide (B₄C), boron oxide (B₂O₃), elemental boron, boric acid (H₃BO₃), and a borate.

In the case where thermal treatment is carried out by use of a known heating apparatus at a temperature increasing rate within a range of the maximum temperature increasing rate and the minimum temperature increasing rate in the apparatus, the temperature increasing rate does not much affect properties of the carbonaceous particles. However, owing to it being a powder, since problems such as cracking which often are involved in a case using a shaped article scarcely occur in this case, from the viewpoint of production cost, the temperature increasing rate is preferably high. The time elapsed from room temperature to the maximum temperature is preferably 12 hours or less, more preferably 6 hours or less, particularly preferably 2 hours or less.

Any known thermal treatment apparatus, such as an Acheson furnace or a direct electrical heating furnace, may be employed for firing. Such an apparatus is advantageous from the viewpoint of production cost. However, since the resistance of the particles may be lowered in the presence of nitrogen gas and the strength of the carbonaceous material may be lowered through oxidation by oxygen, it is preferable that a furnace having a structure such that the inside of the furnace can be filled with an inert gas such as argon or helium be employed. Preferred examples of such a furnace include a batch furnace in which a reaction container can be substituted by gas after evacuation, and a batch furnace or a continuous furnace having a tubular shape in which the interior atmosphere can be controlled.

In the present invention, the carbon layer which the organic compound is deposited onto and/or permeated into has a high crystallinity, preferably having the peak intensity ratio of 0.4 or less at 1,360 cm⁻¹ to that of a peak at 1,580 cm⁻¹ in a laser Raman spectrum. When the peak intensity ratio is 0.4 or more, the carbon layer exhibits insufficient crystallinity, and discharging capacity and coulombic efficiency of the carbon material for forming a battery electrode are unpreferably lowered.

Although the peak intensity ratio is within a range of approximately 0.7 to 0.9 when boron is added in graphitization process, discharging capacity and coulombic efficiency can be well maintained.

[6] Carbon Material for Forming a Battery Electrode

The carbon material for forming a battery electrode of the present invention, produced through the above-described method, contains carbon powder exhibiting the below-described physical properties.

Preferably, graphite crystal structure regions and amorphous structure regions are distributed throughout the entirety of the carbon powder from the surface to a center core portion, and, in a transmission electron microscope bright-field image of an arbitrarily selected 5-μm square region in the cross section of a thin piece obtained by cutting each of the particles constituting the carbon material, the area ratio of a graphite crystal structure region having a diffraction pattern formed of two or more spots to an amorphous structure region having a diffraction pattern formed of only one spot attributed to (002) plane is 99 to 30:1 to 70.

When the area ratio is lower than 30:70, the resultant negative electrode material fails to exhibit high discharging capacity, whereas when the area ratio is higher than 99:1, coulombic efficiency is lowered and irreversible capacity is increased, which is a common problem with a case where graphite crystals are employed as a negative electrode material.

The carbon powder preferably has an average roundness of 0.85 to 0.99 as measured by use of a flow particle image analyzer (the measurement method is described below in Examples).

When the average roundness is smaller than 0.85, the packing density of the powder fails to increase during the course of formation of an electrode, leading to lowering of discharging capacity per unit volume. In contrast, the average roundness greater than 0.99 means that the carbonaceous particles contain virtually no fine particles which have low roundness, and thus discharging capacity fails to increase during the course of formation of an electrode. Preferably, the amount of particles having a roundness of less than 0.90 contained in the carbon powder is regulated to 2 to 20% by number of particles.

The carbon powder preferably has an average particle size of 10 to 40 μm as measured by means of the laser diffraction scattering method. More preferably, the average particle size is 10 to 30 μm.

In the case where the average particle size is large, when a negative electrode of a secondary battery is formed from the carbon powder, the carbon powder is micronized through charging/discharging reaction, leading to deterioration of cycle characteristics. When the carbon powder contains particles having a particle size of 80 μm or more, large amounts of irregularities are formed on the surface of the resultant electrode, thereby causing generation of scratches on a separator to be employed in a battery.

When the average particle size of the carbon powder is small, the particles of the powder fail to efficiently participate in electrochemical reaction with lithium ions, leading to lowering of capacity and deterioration of cycle characteristics. In addition, when the particle size of the carbon powder is small, aspect ratio tends to become high, and specific surface area tends to become large. In the case of production of a battery electrode, in general, the negative electrode material is mixed with a binder to prepare a paste, and the resultant paste is applied to a collector. When the negative electrode material contains small particles having a particle size of 1 μm or less, the viscosity of the paste is increased, and applicability of the paste is lowered.

Therefore, preferably, the negative electrode material contains substantially neither particles having a particle size of 1 μm or less nor particles having a particle size of 80 μm or more.

In the carbon powder, preferably, Co of a (002) plane as measured through X-ray diffractometry is 0.6703 to 0.6800 nm (0.33515 to 0.3400 nm as reduced to average interlayer distance (d₀₀₂)), La (the crystallite size as measured in the a-axis orientation) is greater than 100 nm, and Lc (the crystallite size as measured in the c-axis orientation) is greater than 100 nm. The carbon powder preferably has a BET specific surface area of 0.2 to 5 m²/g, more preferably 3 m²/g or less. When the specific surface area is large, surface activity of the particles of the carbon powder is increased. Therefore, when such carbon powder is employed for forming an electrode of a lithium ion battery, coulombic efficiency is lowered as a result of decomposition of an electrolytic solution and the like. The carbon powder preferably has a true density of 2.21 to 2.23 g/cm³. In the carbon powder, laser Raman R value (the intensity peak ratio at 1,360 cm⁻¹ to that of a peak at 1,580 cm⁻¹ in the laser Raman spectrum) is preferably 0.01 to 0.9, more preferably 0.1 to 0.8.

[7] Secondary Battery

The carbon material for forming a battery electrode of the present invention is suitable for use as a negative electrode material for producing a lithium ion secondary battery. A lithium ion secondary battery can be produced from the carbon material of the present invention by means of any known method.

An electrode of a lithium ion secondary battery can be produced through the following procedure, as in a conventional manner: a binder is diluted with a solvent and then kneaded with the carbon material of the present invention (negative electrode material) in a general manner, to thereby prepare a paste; and the paste is applied to a collector (substrate).

Examples of the binder which may be employed include known binders, such as fluorine-containing polymers (e.g., polyvinylidene fluoride and polytetrafluoroethylene), and rubbers (e.g., SBR (styrene-butadiene rubber)). As solvent, known solvent suitable for the respective binder used may be employed. When a fluorine-containing polymer, a known solvent, for example, toluene or N-methylpyrrolidone, is employed as a solvent. When SBR is employed as a binder, for example, water is employed as a solvent.

The amount of the binder to be employed is preferably 0.5 to 20 parts by mass, particularly preferably about 1 to about 10 parts by mass, on the basis of 100 parts by mass of the negative electrode material.

Kneading of the carbon material of the present invention with the binder may be carried out by use of any known apparatus such as a ribbon mixer, a screw kneader, a Spartan ryuzer, a Lodige mixer, a planetary mixer, or a general-purpose mixer.

The thus-kneaded mixture may be applied to a collector by means of any known method. For example, the mixture is applied to the collector by use of a doctor blade, a bar coater, or a similar apparatus, and then the resultant collector is subjected to molding through roll pressing and the like.

Examples of the collector material which may be employed include known materials such as copper, aluminum, stainless steel, nickel, and alloys thereof.

Any known separator may be employed, but polyethylene- or polypropylene-made microporous film (thickness: 5 to 50 μm) is particularly preferred.

In the lithium ion battery of the present invention, the electrolytic solution may be a known organic electrolytic solution, and the electrolyte may be a known inorganic solid electrolyte or polymer solid electrolyte. From the viewpoint of electrical conductivity, an organic electrolytic solution is preferred.

Preferred examples of the organic solvent employed for preparing the organic electrolytic solution include ethers such as diethyl ether, dibutyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol dimethyl ether, and ethylene glycol phenyl ether; amides such as formamide, N-methylformamide, N,N-dimethylformamide, N-ethylformamide, N,N-diethylformamide, N-methylacetamide, N,N-dimethylacetamide, N-ethylacetamide, N,N-diethylacetamide, N, N-dimethylpropionamide, and hexamethylphosphoryl amide; sulfur-containing compounds such as dimethyl sulfoxide and sulfolane; dialkyl ketones such as methyl ethyl ketone and methyl isobutyl ketone; cyclic ethers such as ethylene oxide, propylene oxide, tetrahydrofuran, 2-methoxytetrahydrofuran, 1,2-dimethoxyethane, and 1,3-dioxolan; carbonates such as ethylene carbonate and propylene carbonate; γ-butyrolactone; N-methylpyrrolidone; acetonitrile; and nitromethane. More preferred examples include esters such as ethylene carbonate, butylene carbonate, diethyl carbonate, dimethyl carbonate, propylene carbonate, vinylene carbonate and γ-butyrolactone; ethers such as dioxolan, diethyl ether, and diethoxyethane; dimethyl sulfoxide; acetonitrile; and tetrahydrofuran. Particularly, carbonate-based non-aqueous solvents such as ethylene carbonate and propylene carbonate are preferably employed. These solvents may be employed singly or in combination of two or more species.

A lithium salt is employed as a solute (electrolyte) which is dissolved in the aforementioned solvent. Examples of generally known lithium salts include LiClO₄, LiBF₄, LiPF₆, LiAlCl₄, LiSbF₆, LiSCN, LiCl, LiCF₃SO₃, LiCF₃CO₂, LiN(CF₃SO₂)₂, and LiN(C₂F₅SO₂)₂.

Examples of the polymer solid electrolyte include polyethylene oxide derivatives and polymers containing the derivatives, polypropylene oxide derivatives and polymers containing the derivatives, phosphoric acid ester polymers, and polycarbonate derivatives and polymers containing the derivatives.

In the lithium ion battery, a lithium-containing transition metal oxide is employed as a positive electrode active substance. Preferably, the positive electrode active substance is an oxide predominantly containing a combination of lithium and at least one transition metal selected from among Ti, V, Cr, Mn, Fe, Co, Ni, Mo, and W, in which the ratio by mol between lithium and the transition metal is 0.3 to 2.2. More preferably, the positive electrode active substance is an oxide predominantly containing a combination of lithium and at least one transition metal selected from among V, Cr, Mn, Fe, Co, and Ni, in which the ratio by mol between lithium and the transition metal is 0.3 to 2.2. The positive electrode active substance may contain Al, Ga, In, Ge, Sn, Pb, Sb, Bi, Si, P, B, etc. in an amount of less than 30 mol % on the basis of the entirety of the transition metal serving as a primary component. Of the aforementioned positive electrode active substances, a preferred substance is at least one species selected from among materials having a formula LiₓMO₂ (wherein M represents at least one element selected from among Co, Ni, Fe, and Mn, and x is 0 to 1.2) or having a spinel structure of Li_{y}N₂O₄ (wherein N includes at least Mn, and y is 0 to 2).

Particularly preferably, the positive electrode active substance is at least one species selected from among materials containing Li_{y}MₐD₁₋ₐO₂ (wherein M represents at least one element selected from among Co, Ni, Fe, and Mn; D represents at least one element selected from among Co, Ni, Fe, Mn, Al, Zn, Cu, Mo, Ag, W, Ga, In, Sn, Pb, Sb, Sr, B, and P, with the proviso that the element corresponding to M being excluded; y is 0 to 1.2; and a is 0.5 to 1); or at least one species selected from among materials having a spinel structure and being represented by the formula Li₂(N_{b}E_{1-b})₂O₄ (wherein N represents Mn; E represents at least one element selected from among Co, Ni, Fe, Mn, Al, Zn, Cu, Mo, Ag, W, Ga, In, Sn, Pb, Sb, Sr, B, and P; b is 1 to 0.2; and z is 0 to 2).

Specific examples of the positive electrode active substance include LiₓCoO₂, LiₓNiO₂, LiₓMnO₂, LiₓCOₐNi₁₋ₐO₂, LiₓCO_{b}V_{1-b}O_{z}, LiₓCO_{b}Fe_{1-b}O₂, LiₓMn₂O₄, LiₓMn_{c}Co_{2-c}O₄, LiₓMn_{c}Ni_{2-c}O₄, LiₓMn_{c}V_{2-c}O₄, and LiₓMn_{c}Fe_{2-c}O₄ (wherein x is 0.02 to 1.2, a is 0.1 to 0.9, b is 0.8 to 0.98, c is 1.6 to 1.96, and z is 2.01 to 2.3). Examples of most preferred lithium-containing transition metal oxides include LiₓCoO₂, LiₓNiO₂, LiₓMnO₂, LiₓCOₐNi₁₋ₐO₂, LiₓMn₂O₄, and LiₓCo_{b}V_{1-b}O_{z} (wherein x is 0.02 to 1.2, a is 0.1 to 0.9, b is 0.9 to 0.98, and z is 2.01 to 2.3). The value x is a value as measured before initiation of charging/discharging, and is increased or decreased through charging/discharging.

No particular limitations are imposed on the average particle size of particles of the positive electrode active substance, but the average particle size is preferably 0.1 to 50 μm. Preferably, the volume of particles having a particle size of 0.5 to 30 μm is 95% or more on the basis of the entire volume of the positive electrode active substance particles. More preferably, the volume of particles having a particle size of 3 μm or less is 18% or less on the basis of the entire volume of the positive electrode active substance particles, and the volume of particles having a particle size of 15 μm to 25 μm inclusive is 18% or less on the basis of the entire volume of the positive electrode active substance particles. No particular limitations are imposed on the specific surface area of the positive electrode active substance, but the specific surface area as measured by means of the BET method is preferably 0.01 to 50 m²/g, particularly preferably 0.2 m²/g to 1 m²/g. When the positive electrode active substance (5 g) is dissolved in distilled water (100 ml), the pH of the supernatant of the resultant solution is preferably 7 to 12 inclusive.

No particular limitations are imposed on the elements (exclusive of the aforementioned elements) which are required for producing a battery.

As described above, the carbon material for forming a battery electrode of the present invention can be employed for producing a negative electrode of a lithium ion secondary battery. In addition, the carbon material of the present invention can be employed for producing a separator of a fuel cell. In this case, the separator is produced so as to contain the carbon material in an amount of 5 to 95 mass %.

### BRIEF DESCRIPTION OF THE DRAWINGS

FIG. 1 shows a transmission electron micrograph of the carbon material powder produced in Example 1.

FIG. 2(A) shows a photograph of a selected area diffraction pattern formed of only one spot attributed to a (002) plane, corresponding to an amorphous structure region; and

FIG. 2(B) shows a photograph of a selected area diffraction pattern formed of two or more spots, corresponding to a graphite crystal structure region.

FIG. 3 shows a transmission electron micrograph of the carbon material powder produced in Comparative Example 2.

FIG. 4 shows a transmission electron micrograph of the carbon material powder produced in Comparative Example 3.

### BEST MODE FOR CARRYING OUT THE INVENTION

The present invention will next be described in more detail with reference to representative examples, which should not be construed as limiting the invention thereto.

In the below-described Examples, physical properties, etc. were measured by means of the following methods.

[1) Average Roundness:

The average roundness of the carbon material was measured by use of flow particle image analyzer FPIA-2100 (product of Sysmex Corporation) as described below.

A measurement sample was subjected to cleaning (removal of micro dust) by use of a 106-μm filter. The sample (0.1 g) was added to ion-exchange water (20 ml), and an anionic/nonionic surfactant (0.1 to 0.5 mass %) was added to the resultant mixture so as to uniformly disperse the sample in the mixture, thereby preparing a dispersion containing the sample. Dispersion of the sample was carried out for five minutes by use of ultrasonic cleaner UT-105S (product of Sharp Manufacturing Systems Corporation).

The summary of measurement principle, etc. is described in, for example, “Funtai to Kogyo,” VOL. 32, No. 2, 2000, and Japanese Patent Application Laid-Open (kokai) No. 8-136439. Specifically, the average roundness is measured as follows.

When the measurement sample dispersion passes through the flow path of a flat, transparent flow cell (thickness: about 200 μm), the dispersion is irradiated with strobe light at intervals of 1/30 seconds, and photographed by a CCD camera. A predetermined number of the thus-captured still images of the dispersion was subjected to image analysis, and the average roundness was calculated by use of the following formula.
Roundness=(the peripheral length of a circle as calculated from a circle-equivalent diameter)/(the peripheral length of a projected image of a particle)

The term “circle-equivalent diameter” refers to the diameter of a circle having a peripheral length equal to the actual peripheral length of a particle that has been obtained from a photograph of the particle. The roundness of the particle is obtained by dividing the peripheral length of a circle as calculated from the circle-equivalent diameter by the actual peripheral length of the particle. For example, a particle having a true round shape has a roundness of 1, whereas a particle having a more complicated shape has a smaller roundness. The average roundness of particles is the average of the roundnesses of the particles as obtained by means of the above-described method.

[2] Average Particle Size:

The average particle size was measured by use of a laser diffraction scattering particle size analyzer (Microtrac HRA, product of Nikkiso Co., Ltd.).

[3] Specific Surface Area:

The specific surface area was measured by use of a specific surface area measuring apparatus (NOVA-1200, product of Yuasa Ionics Inc.) by means of the BET method, which is generally employed for specific surface area measurement.

[4] Battery Evaluation Method:

(1) Preparation of Paste:

0.1 Parts by mass of KF Polymer L1320 (an N-methylpyrrolidone (NMP) solution product containing 12 mass % polyvinylidene fluoride (PVDF), product of Kureha Chemical Industry Co., Ltd.) was added to 1 part by mass of a negative electrode material, and the resultant mixture was kneaded by use of a planetary mixer, to thereby prepare a neat agent.

(2) Formation of Electrode:

NMP was added to the neat agent so as to regulate the viscosity of the agent. The resultant mixture was applied onto a copper foil of high purity by use of a doctor blade so as to attain a thickness of 250 μm. The resultant product was dried under vacuum at 120° C. for one hour, and then subjected to punching, to thereby form an electrode having a size of 18 mmφ. The thus-formed electrode was sandwiched between super-steel-made pressing plates, and then subjected to pressing such that a pressure of about 1×10² to 3×10² N/mm² (1×10³ to 3×10³ kg/cm²) was applied to the electrode. Thereafter, the resultant electrode was dried in a vacuum drying apparatus at 120° C. for 12 hours, and was employed for evaluation.

(3) Production of Battery:

A three-electrode cell was produced as follows. The below-described procedure was carried out in an atmosphere of dried argon having a dew point of −80° C. or lower.

In a polypropylene-made cell (inner diameter: about 18 mm) having a screw cap, a separator (polypropylene-made microporous film (Celgard 2400)) was sandwiched between the carbon electrode with copper foil (positive electrode) which had been formed above in (2), and a metallic lithium foil (negative electrode), to thereby form a laminate. Subsequently, a metallic lithium foil serving as a reference electrode was laminated in a manner similar to that described above. Thereafter, an electrolytic solution was added to the cell, and the resultant cell was employed for testing.

(4) Electrolytic Solution:

The electrolytic solution was prepared by dissolving LiPF₆ (1 mol/liter), serving as an electrolyte, in a mixture of EC (ethylene carbonate) (8 parts by mass) and DEC (diethyl carbonate) (12 parts by mass).

(5) Charging/Discharging Cycle Test:

Constant-current constant-voltage charging/discharging test was performed at a current density of 0.2 mA/cm² (corresponding to 0.1 C).

Constant-current (CC) charging (i.e., intercalation of lithium ions into carbon) was performed at 0.2 mA/cm² while voltage was increased from rest potential to 0.002 V. Subsequently, constant-voltage (CV) charging was performed at 0.002 V, and charging was stopped when the current value decreased to 25.4 μA.

CC discharging (i.e., release of lithium ions from carbon) was performed at 0.2 mA/cm² (corresponding to 0.1 C), and was cut off at a voltage of 1.5 V.

### EXAMPLE 1

There were employed carbonaceous particles serving as core material, which had an average particle size of 20 μm as measured by means of the laser diffraction scattering method and an average roundness of 0.88, in which the area ratio of crystalline carbon regions of the particles to amorphous carbon regions thereof in a transmission electron microscope bright-field image of the particles obtained is 80:20.

The carbonaceous particles (500 parts by mass), phenol (398 parts by mass), 37% formalin (466 parts by mass), hexamethylenetetramine serving as a reaction catalyst (38 parts by mass), and water (385 parts by mass) were placed into a reaction container. The resultant mixture was stirred at 60 rpm for 20 minutes. Subsequently, while the mixture was stirred, the container was evacuated to 0.4 kPa (3 Torr) and maintained at the pressure for five minutes, and the pressure in the container was returned to atmospheric pressure. This procedure was carried out three times, to thereby cause the liquid to permeate into the inside of the particles. While stirring of the mixture was further continued, the mixture was heated to 150° C. and maintained at the temperature. At the initial stage of reaction, the mixture in the container exhibited fluidity similar to that of mayonnaise. However, as reaction proceeded, a product containing graphite which product was obtained through reaction between phenol and formaldehyde, began to be separated from a layer predominantly containing water, and, about 15 minutes later, a black granular product formed of graphite and phenol resin was dispersed in the reaction container. Thereafter, the resultant reaction mixture was stirred at 150° C. for 60 minutes, and then the resultant product in the reaction container was cooled to 30° C., followed by stopping of stirring. The product in the container was subjected to filtration, and the thus-obtained black granular product was washed with water. The granular product was further subjected to filtration, and dried by use of a fluidized bed dryer for 5 hours (hot air temperature: 55° C.), to thereby yield a graphite-phenol resin granular product.

Subsequently, the graphite-phenol resin granular product was pulverized by use of a Henschel mixer at 1,800 rpm for 5 minutes. The thus-pulverized product was placed in a heating furnace, and the inside of the furnace was evacuated and then filled with argon. Subsequently, the furnace was heated under a stream of argon gas. The temperature of the furnace was maintained at 2,900° C. for 10 minutes, and then the furnace was cooled to room temperature. Thereafter, the thus-treated product was subjected to screening by use of a sieve of 63-μm mesh, to thereby produce a negative electrode material sample having an undersize of 63 μm.

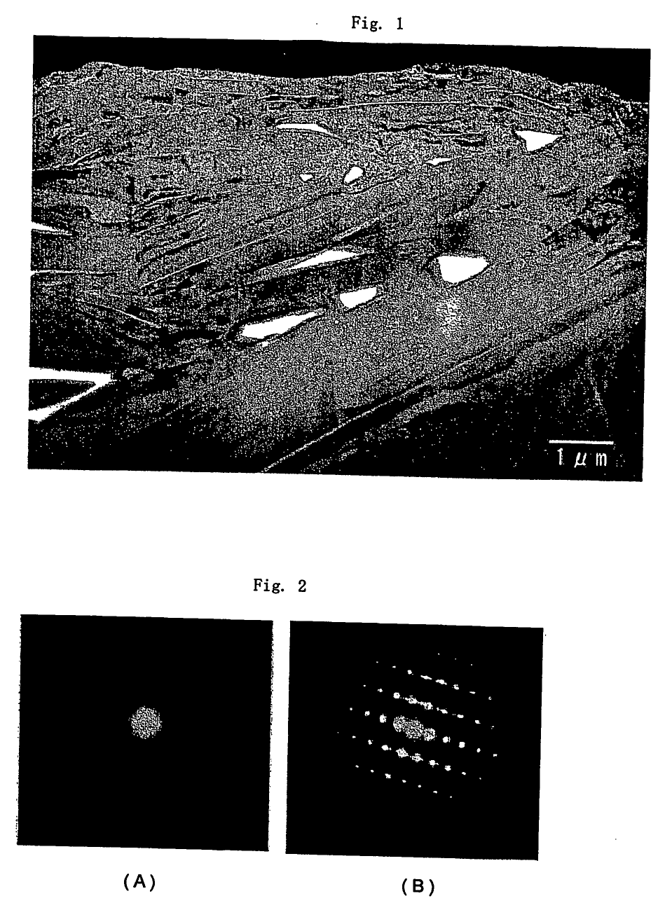

FIG. 1 shows a transmission electron micrograph (×25,000) of the thus-produced sample. In an arbitrarily selected square region (5 μm×5 μm) of the micrograph of FIG. 1, the area ratio of a region having a selected area diffraction pattern formed of two or more spots (FIG. 2(B)) to a region having a selected area diffraction pattern formed of only one spot attributed to a (002) plane (FIG. 2(A)) was found to be 85:15.

The peak intensity ratio (laser Raman R value) at 1,360 cm⁻¹ to that of a peak at 1,580 cm⁻¹ in the laser Raman spectrum of the surface of the sample, i.e., 1,580 cm⁻¹ peak intensity/1,360 cm⁻¹ peak intensity, was found to be 0.05. In addition, the average particle size, specific surface area, Co, and average roundness of the sample were found to be 25 μm, 1.1 m²/g, 0.6716 nm, and 0.934, respectively. The results are shown in Table 1.

The sample was employed for battery evaluation. In the charging/discharging cycle test, the capacity and coulombic efficiency at the 1st cycle and the capacity at the 50th cycle were measured. The results are shown in Table 2.

### EXAMPLE 2

The procedure of Example 1 was repeated, except that particles having been obtained through granulation of flaky graphite (average particle size: 5 μm) by use of a Lodige mixer and having an average particle size of 20 μm as measured by means of the laser diffraction scattering method and an average roundness of 0.88 was employed as carbonaceous particles serving as core material, to thereby produce a carbon material. Physical properties of the thus-produced carbon material were measured, and the material was employed for battery evaluation. The results are shown in Tables 1 and 2.

### EXAMPLE 3

Water (5.0 parts by mass) was added to an ethanol solution of a phenol resin monomer (BRS-727, product of Showa Highpolymer Co., Ltd.) (5.5 parts by mass as reduced to resin solid content), and the resultant mixture was stirred such that the solution was completely dissolved in water. The resultant solution was added to carbonaceous particles similar to those employed in Example 1 such that the phenol resin solid content was 10 mass % on the basis of the entirety of the carbonaceous particles, and the resultant mixture was kneaded by use of a planetary mixer for 30 minutes. The resultant mixture was dried in a vacuum dryer at 150° C. for 2 hours. The thus-dried product was placed in a heating furnace, and the inside of the furnace was evacuated and then filled with argon. Subsequently, the furnace was heated under a stream of argon gas. The temperature of the. furnace was maintained at 2,900° C. for 10 minutes, and then the furnace was cooled to room temperature. Thereafter, the thus-treated product was subjected to screening by use of a sieve of 63-μm mesh, to thereby produce a negative electrode material sample having an undersize of 63 μm.

The peak intensity ratio (laser Raman R value) at 1,360 cm⁻¹ to that of a peak at 1,580 cm⁻¹ in the laser Raman spectrum of the surface of the sample, i.e., 1,580 cm⁻¹ peak intensity/1,360 cm⁻¹ peak intensity, was found to be 0.15. Other physical properties of the sample are shown in Table 1. The battery evaluation results obtained by use of the sample are shown in Table 2.

### EXAMPLE 4

The procedure of Example 1 was repeated, except that vapor grown carbon fiber which had been graphitized at 2,800° C. (fiber diameter: 150 nm, aspect ratio: 100) (5 mass %) was added to the reaction container before initiation of reaction and mixed with the raw materials under stirring, to thereby produce a carbon material. Physical properties of the thus-produced carbon material were measured, and the material was employed for battery evaluation. The results are shown in Tables 1 and 2.

### EXAMPLE 5

The procedure of Example 1 was repeated, except that B₄C (product of Denka) (0.01 mass %) was added to the graphite-phenol resin granular product of Example 1, and that the resultant mixture was pulverized by use of a Henschel mixer at 1,800 rpm for five minutes, to thereby produce a carbon material. Physical properties of the thus-produced carbon material were measured, and the material was employed for battery evaluation. The results are shown in Tables 1 and 2.

### COMPARATIVE EXAMPLE 1

The procedure of Example 1 was repeated, except that there were employed, as carbonaceous particles serving as core material, natural graphite particles having an average particle size of 23 μm as measured by means of the laser diffraction scattering method, and an average roundness of 0.83, in which the area ratio of crystalline carbon regions of the particles to amorphous carbon regions thereof is 997:3 as calculated from a bright-field image of the particles obtained by use of a transmission electron microscope, to thereby produce a carbon material. Physical properties of the thus-produced carbon material are shown in Table 1.

In a square region (5 μm×5 μm) of a bright-field image of the carbon material obtained by use of a transmission electron microscope, the area ratio of crystalline carbon regions of the material to amorphous carbon regions thereof was found to be 80:20 in the vicinity of the surface of the material and 995:5 in the vicinity of the central core of the material; i.e., the area ratio was found to be non-uniform in the carbon material.

The carbon material was employed for battery evaluation in a manner similar to that of Example 1. The results are shown in Table 2.

### COMPARATIVE EXAMPLE 2

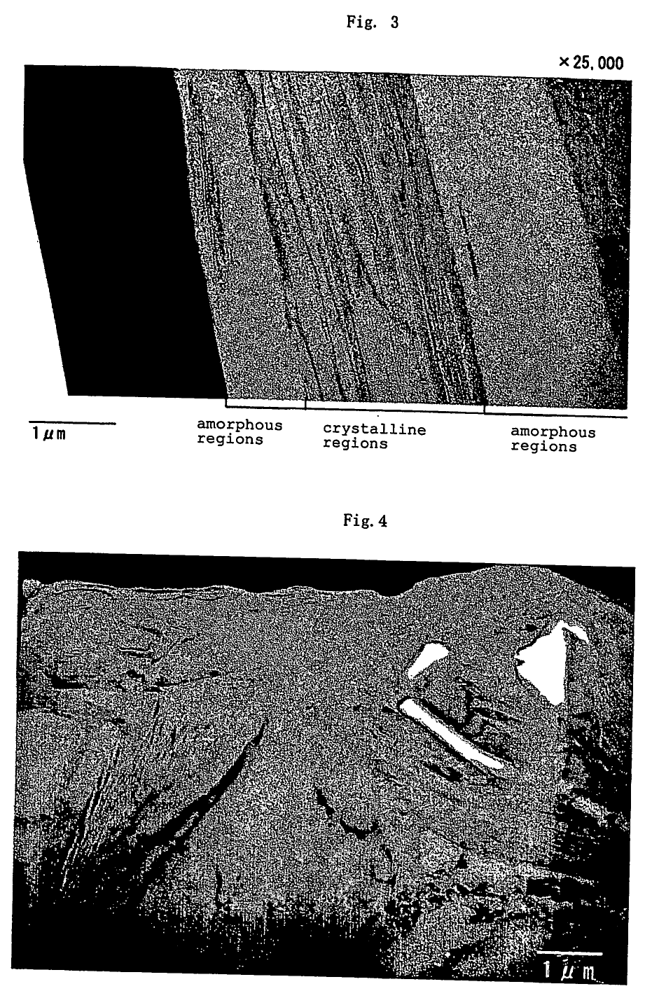

A carbon material was produced from carbonaceous particles similar to those employed in Example 1 without forming a carbon layer on the surfaces of the particles. FIG. 3 shows a transmission electron micrograph (×25,000) of the carbon material.

In a manner similar to that of Example 1, physical properties of the thus-produced carbon material were measured, and the carbon material was employed for battery evaluation. The results are shown in Tables 1 and 2.

### COMPARATIVE EXAMPLE 3

The procedure of Example 1 was repeated, except that the final thermal treatment was performed at 1,000° C., to thereby produce a carbon material. FIG. 4 shows a transmission electron micrograph (×25,000) of a cross section of the carbon material. In an arbitrarily selected square region (5 μm×5 μm) of the micrograph of FIG. 4, the area ratio of a region having a selected area diffraction pattern formed of two or more spots to a region having a selected area diffraction pattern formed of only one spot attributed to a (002) plane was found to be 25:75 in the vicinity of the surface of the material and 70:30 in the vicinity of the central core of the material; i.e., the area ratio was found to be non-uniform in the carbon material.

In a manner similar to that of Example 1, physical properties of the thus-produced carbon material were measured, and the carbon material was employed for battery evaluation. The results are shown in Tables 1 and 2.

TABLE 1

| | Average | | Specific | | |
|---|---|---|---|---|---|
| | particle size | Laser Raman | surface area | C₀ | Average |
| | μm | R value | m²/g | nm | roundness |
| Ex. 1 | 25 | 0.05 | 1.1 | 0.6716 | 0.934 |
| Ex. 2 | 26 | 0.12 | 1.3 | 0.6717 | 0.938 |
| Ex. 3 | 26 | 0.15 | 1.0 | 0.6716 | 0.935 |
| Ex. 4 | 26 | 0.20 | 1.5 | 0.6718 | 0.928 |
| Ex. 5 | 25 | 0.37 | 1.3 | 0.6718 | 0.937 |
| Comp. | 24 | 0.10 | 1.4 | 0.6719 | 0.880 |
| Ex. 1 | | | | | |
| Comp. | 24 | 0.23 | 4.6 | 0.6717 | 0.927 |
| Ex. 2 | | | | | |
| Comp. | 28 | 0.80 | 3.5 | 0.6750 | 0.920 |
| Ex. 3 | | | | | |

TABLE 2

| | Capacity | Coulombic | Capacity |
|---|---|---|---|
| | (mAh/g) | efficiency (%) | (mAh/g) |
| | (1st cycle) | (1st cycle) | (50th cycle) |
| Ex. 1 | 360 | 94 | 356 |
| Ex. 2 | 352 | 93 | 349 |
| Ex. 3 | 350 | 92 | 345 |
| Ex. 4 | 353 | 93 | 352 |
| Ex. 5 | 351 | 93 | 348 |
| Comp. Ex. 1 | 350 | 90 | 325 |
| Comp. Ex. 2 | 350 | 89 | 310 |
| Comp. Ex. 3 | 320 | 85 | 300 |

### INDUSTRIAL APPLICABILITY

By producing a carbon material which has crystalline carbon regions and amorphous carbon regions which are observable by a transmission electron microscope bright-field image, the present invention provides the carbon material suitable as a negative electrode material for producing a lithium ion secondary battery having high discharging capacity and low irreversible capacity, and exhibiting excellent coulombic efficiency and excellent cycle characteristics. The carbon material production method of the present invention is advantageous from the viewpoints of production cost and mass productivity, which uses an easy-to-handle coating material and is improved in safety.

1. A carbon material for forming a battery electrode, comprising carbon powder having a homogeneous structure which is produced by causing an organic compound, serving as a raw material of a polymer, to deposit onto and/or permeate into carbonaceous particles, and subsequently polymerizing the organic compound, followed by thermal treatment at a temperature of 1,800 to 3,300° C.

2. The carbon material for forming a battery electrode according to claim 1, wherein the polymerization is carried out under heating at a temperature of 100 to 500° C.

3. The carbon material for forming a battery electrode according to claim 1, wherein the organic compound is a raw material of at least one polymer selected from the group consisting of a phenol resin, a polyvinyl alcohol resin, a furan resin, a cellulose resin, a polystyrene resin, a polyimide resin, and an epoxy resin.

4. The carbon material for forming a battery electrode according to claim 3, wherein the organic compound is a raw material of a phenol resin.

5. The carbon material for forming a battery electrode according to claim 4, wherein a drying oil or a fatty acid derived therefrom is added during the course of reaction of the phenol resin raw material.

6. The carbon material for forming a battery electrode according to claim 1, wherein a graphite crystal structure region and an amorphous structure region are distributed throughout the entirety of a particle constituting the carbon material from the surface of the particle to a center portion thereof.

7. The carbon material for forming a battery electrode according to claim 6, wherein, with respect to a transmission electron microscope bright-field image of a cross section of a thin piece obtained by cutting each of the particles constituting the carbon material for forming a battery electrode, in a selected area diffraction pattern of an arbitrarily selected 5-μm square region in the section, the area ratio of a graphite crystal structure region having a diffraction pattern formed of two or more spots to an amorphous structure region having a diffraction pattern formed of only one spot attributed to (002) plane is 99 to 30:1 to 70.

8. The carbon material for forming a battery electrode according to claim 1, which is produced by performing multiple times a process of causing the organic compound to deposit onto and/or permeate into the carbonaceous particles and subsequently polymerizing the organic compound, followed by thermal treatment at a temperature of 1,800 to 3,300° C.

9. The carbon material for forming a battery electrode according to claim 1, wherein the amount of the organic compound is 4 to 500 parts by mass on the basis of 100 parts by mass of the carbonaceous particles.

10. The carbon material for forming a battery electrode according to claim 9, the amount of the organic compound is 100 to 500 parts by mass on the basis of 100 parts by mass of the carbonaceous particles.

11. The carbon material for forming a battery electrode according to claim 1, which contains boron in an amount of 10 to 5,000 ppm.

12. The carbon material for forming a battery electrode according to claim 11, wherein boron or a boron compound is added after polymerization of the organic compound, followed by thermal treatment at 1,800 to 3,300° C.

13. The carbon material for forming a battery electrode according to claim 1, wherein the carbonaceous particles are natural graphite particles, particles formed of petroleum pitch coke, or particles formed of coal pitch coke.

14. The carbon material for forming a battery electrode according to claim 13, wherein the carbonaceous particles have an average particle size of 10 to 40 μm and an average roundness of 0.85 to 0.99.

15. The carbon material for forming a battery electrode according to claim 1, which contains carbon fiber having a filament diameter of 2 to 1,000 nm.

16. The carbon material for forming a battery electrode according to claim 15, wherein at least a portion of the carbon fiber is deposited onto the surface of the carbon powder.

17. The carbon material for forming a battery electrode according to claim 15, wherein the amount of the carbon fiber is 0.01 to 20 parts by mass on the basis of 100 parts by mass of the carbonaceous particles.

18. The carbon material for forming a battery electrode according to claim 15, wherein the carbon fiber is vapor grown carbon fiber, each fiber filament of the carbon fiber having an aspect ratio of 10 to 15,000.

19. The carbon material for forming a battery electrode according to claim 18, wherein the vapor grown carbon fiber is graphitized carbon fiber which has undergone thermal treatment at 2,000° C. or higher.

20. The carbon material for forming a battery electrode according to claim 18, wherein each fiber filament of the vapor grown carbon fiber includes a hollow space extending along its center axis.

21. The carbon material for forming a battery electrode according to claim 18, wherein the vapor grown carbon fiber contains branched carbon fiber filaments.

22. The carbon material for forming a battery electrode according to claim 18, wherein the vapor grown carbon fiber has, at (002) plane, an average interlayer distance (d₀₀₂) of 0.344 nm or less as measured by means of X-ray diffractometry.

23. The carbon material for forming a battery electrode according to claim 1, wherein the carbon powder satisfies at least one of the following requirements (1) through (6):
(1) average roundness as measured by use of a flow particle image analyzer is 0.85 to 0.99;
(2) C₀ of (002) plane as measured through X-ray diffractometry is 0.6703 to 0.6800 nm, La (the crystallite size as measured in the a-axis orientation) is greater than 100 nm, and Lc (the crystallite size as measured in the c-axis orientation) is greater than 100 nm;
(3) BET specific surface area is 0.2 to 5 m²/g;
(4) true density is 2.21 to 2.23 g/cm³;
(5) laser Raman R value (the ratio of the intensity of a peak at 1,360 cm⁻¹ to that of a peak at 1,580 cm⁻¹ in the laser Raman spectrum) is from 0.01 to 0.9; and
(6) average particle size as measured through laser diffractometry is 10 to 40 μm.

24. A method for producing a carbon material for forming a battery electrode containing carbon powder having a homogeneous structure, comprising a step of treating carbonaceous particles with an organic compound serving as a raw material of a polymer or a solution of the organic compound, to thereby cause the organic compound to deposit onto and/or permeate into the carbonaceous particles; a step of polymerizing the organic compound; and a step of thermally treating the resultant product at a temperature of 1,800 to 3,300° C.

25. A method for producing a carbon material for forming a battery electrode containing carbon powder having a homogeneous structure and carbon fiber, comprising a step of treating carbonaceous particles with a mixture of an organic compound serving as a raw material of a polymer and carbon fiber having a filament diameter of 2 to 1,000 nm or with a solution of the mixture, to thereby cause the organic compound to deposit onto and/or permeate into the carbonaceous particles and cause the carbon fiber to adhere to the particles; a step of polymerizing the organic compound; and a step of thermally treating the resultant product at a temperature of 1,800 to 3,300° C.,
wherein at least a portion of the carbon fiber is deposited onto the surface of the carbon powder.

26. An electrode paste comprising the carbon material for forming a battery electrode as recited in claim 1, and a binder.

27. An electrode comprising a molded product of the electrode paste as recited in claim 26.

28. A battery comprising the electrode as recited in claim 27.

29. A secondary battery comprising the electrode as recited in claim 27.

30. The secondary battery according to claim 29, which comprises a non-aqueous electrolytic solution and/or a non-aqueous polymer electrolyte, wherein a non-aqueous solvent employed for the non-aqueous electrolytic solution and/or the non-aqueous polymer electrolyte contains at least one selected from the group consisting of ethylene carbonate, diethyl carbonate, dimethyl carbonate, methyl ethyl carbonate, propylene carbonate, butylene carbonate, and vinylene carbonate.

31. A fuel cell separator comprising, in an amount of 5 to 95 mass %, the carbon material for forming a battery electrode as recited in claim 1.

32. A fuel cell comprising the fuel cell separator as recited in claim 31.
